(19) United States
(12) Patent Application Publication
(10) Pub. No.: US 2025/0078126 A1
(43) Pub. Date: Mar. 6, 2025

(54) System and Method for a Hybrid Brick-and-Mortar and Digital Retail Environment

(71) Applicant: Fianci Innovation Ltd., Rehovot (IL)

(72) Inventors: Alexander TSUDIK, Gaash (IL); Chai SORYA, Rehovot (IL)

(21) Appl. No.: 18/241,872

(22) Filed: Sep. 3, 2023

(51) Int. Cl. G06Q 30/0601; G06K 7/10; G06Q 30/0251

(52) U.S. Cl. CPC G06Q 30/0623; G06K 7/10297; G06Q 30/0255; G06Q 30/0621; G06Q 30/0631; G06Q 30/0643

(57) ABSTRACT

A system including an automation module configured to receive data in response to a trigger, wherein the trigger is indicative of an interaction between a physical item and a consumer, the data including information related to the consumer; a user interface configured to facilitate interactions between the consumer and a digital representation of the physical item; wherein the automation module is configured to collect interaction data from the interactions between consumer and the digital representation.

### FIELD OF THE INVENTION

The present invention relates to a hybrid brick-and-mortar and digital retail environment and, more particularly, to a system and method for combining physical store elements with digital technology to enhance the retail experience.

### BACKGROUND OF THE INVENTION

Traditional brick-and-mortar retail stores have long been the cornerstone of shopping experiences, allowing customers to physically browse and interact with products before making a purchase. However, the advent of digital technology has brought about significant changes in consumer behavior and expectations. Online shopping platforms and e-commerce have provided customers with convenience, a vast array of choices, and personalized shopping experiences. Despite the benefits of e-commerce, many customers still prefer the tactile experience of physically examining products before buying.

The challenge for retailers is to bridge the gap between the advantages of traditional in-store shopping and the conveniences of digital retail. To address this challenge, various retail technologies have emerged, attempting to integrate the best of both worlds. One notable advancement is the use of Near Field Communications (NFC) and RFID technology, allowing products to be tagged with unique identifiers that can interact with smartphones and other NFC-enabled devices. However, while NFC and RFID technology offer opportunities for connecting physical products with digital information, there is a need for a more comprehensive system that seamlessly blends the brick-and-mortar and digital shopping experiences.

### SUMMARY OF THE INVENTION

In exemplary embodiments, the system uses NFC tags on displayed products, enabling customers to use their smartphones to access product information, make purchases, and customize items through a user-friendly application. The invention also utilizes machine learning for personalized recommendations and optimizes in-store product placement based on customer interactions. This innovative approach revolutionizes traditional retail practices, providing a seamless and customer-centric shopping environment.

The present invention seeks to overcome these limitations by providing a hybrid brick-and-mortar and digital retail environment. This novel system and method offer a user-friendly solution that empowers customers to engage with products in physical stores while leveraging the benefits of digital technology. The “constructor engine” feature introduces an innovative way for customers to customize displayed products through a mobile application. This customization capability not only enhances the shopping experience but also opens up new possibilities for personalized and made-to-order products. In addition, the invention's integration of machine learning algorithms provides valuable insights into customer preferences and behaviors. By collecting and analyzing statistical data, the system optimizes product placement within the store, tailoring the shopping experience to individual needs and preferences.

According to the present invention there is provided a system including: a computer system having a database including a plurality of SKUs; a plurality of NFC tags that are each collocated with a respective article and configured to be associated with a corresponding SKU by associating a MAC address of one NFC tag with a corresponding SKU in the database, wherein the data fields of the NFC tags are empty.

According to further features in preferred embodiments of the invention described below the system further includes: a software application installable on a mobile device, the software application being associated with and in communication with the computer system, wherein scanning an NFC tag with the mobile device having the software application installed thereon results in a GUI of the software application displaying a representation of the article collocated with the NFC tag in a display of the mobile device.

According to still further features the software application includes a constructor engine adapted for customizing a product by digitally substituting one or more existing components of the article with one or more corresponding alternative components selected from a set of alternative components displayed on the GUI.

According to still further features the alternative components of the set of alternative components are compiled from other SKUs in the database. According to still further features the alternative components of the set of alternative components have dimensions of size and shape that are similar to the existing components, having a predefined threshold by which the dimensions are allowed to differ from corresponding dimensions of the existing components.

According to another embodiment there is provided a system including: an automation module configured to receive data in response to a trigger, wherein the trigger is indicative of an interaction between a physical item and a consumer, the data including information related to the consumer; a user interface configured to facilitate interactions between the consumer and a digital representation of the physical item; wherein the automation module is configured to collect interaction data from the interactions between consumer and the digital representation.

According to still further features the automation module facilitates autonomous decision-making, automated actions that align with observed consumer behavior, or both. According to still further features the data is received from a data source, the data being indicative of a customer behavior or activity. According to still further features the data source is a sensor.

According to still further features the interactions include adding, subtracting, changing, and substituting features of the digital representation. According to still further features the interaction data is used to produce promotional materials. According to still further features the interaction data is used by artificial intelligence software to improve conversions.

According to still further features the automation module uses artificial intelligence (AI) to analyze the interaction data to predict which products the customer is likely to be interested in and target promotional material accordingly.

According to another embodiment there is provided a system including: an automation module configured to receive data in response to a trigger, wherein the trigger is indicative of an interaction between a physical item and a consumer, the data including information related to the consumer; a user interface configured to facilitate interactions between the consumer and a digital representation of the physical item; wherein the automation module is configured to collect interaction data from the interactions between consumer and the digital representation; wherein the automation module automatically updates marketing campaigns based on designs of most viewed products in each store branch based on the interaction data; and wherein the automation module adjusts promotions in advertising to most common customer budget ranges in each store branch, the adjustments including automatic selection of products to feature in advertisements based on the average customer budget at each branch and the customization of advertising content to highlight products within the average budget range.

### BRIEF DESCRIPTION OF THE DRAWINGS

Various embodiments are herein described, by way of example only, with reference to the accompanying drawings, wherein:

FIG. 1 is a flow diagram 100 of an example embodiment of a method according to the present invention;

FIG. 2 is a diagrammatic representation of an example system according to the present invention;

FIG. 3 is an example embodiment implementing the system and process;

FIG. 4 is an example embodiment of the GUI;

FIG. 5 is an optional embodiment of the invention;

FIG. 6 is an optional embodiment of the invention;

FIG. 7 is a representation of an example embodiment of the invention;

FIG. 8 is an example embodiment according to FIG. 7;

FIG. 9 is a representation of an example embodiment including autonomous decision-making and/or automated actions;

FIG. 10 is an example embodiment whereby data is received from a data source 360, such as a sensor;

FIG. 11 is an example embodiment of the system wherein the interaction data 314 is used to produce promotional materials;

FIG. 12 is an example embodiment of the system where the interaction data 314 is used to train machine learning models;

FIG. 13 is an example embodiment of the system where the interaction data 314 is used by artificial intelligence software 376 to improve conversions;

FIG. 14 is an example embodiment of the system where the automation module uses artificial intelligence (AI) 376 to analyze the interaction data;

FIG. 15 is an example embodiment of the invention.

### DESCRIPTION OF THE PREFERRED EMBODIMENTS

The principles and operation of a system and method for a hybrid brick-and-mortar and digital retail environment according to the present invention may be better understood with reference to the drawings and the accompanying description.

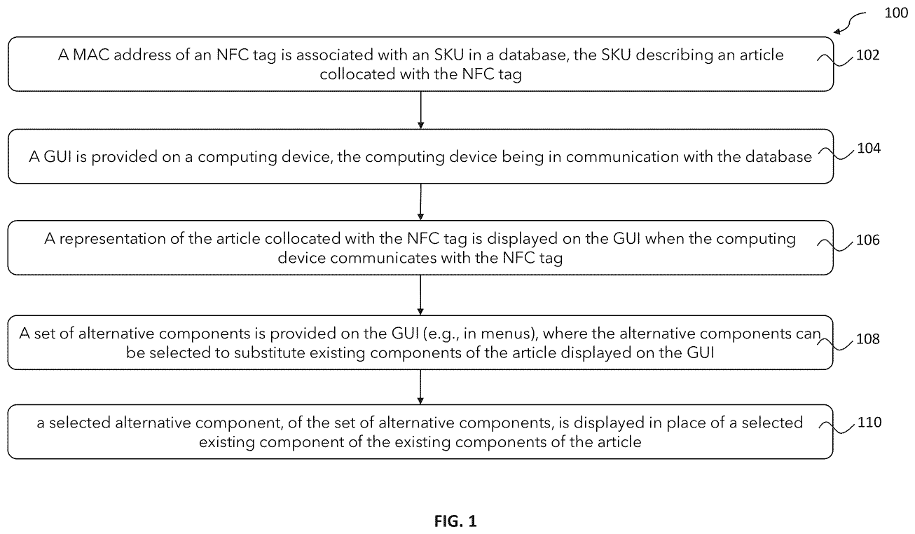

Referring now to the drawings, FIG. 1 illustrates a flow diagram 100 of an example embodiment of a method according to the present invention.

As a high-level overview, the present system and method entails a brick-and-mortar store that displays various products (e.g., a clothing store, a jewelry store, an electronics store, etc.) where each product is has a Near Field Communications (NFC) tag to identify the article or product to the store's computer system. The user's mobile device (e.g., a smartphone) has a system application installed or running on the device. The application is associated with the store's computer system. The user scans the tag with their NFC-enabled smartphone and the application identifies the article. At this point the article can be purchased.

Another level or capability of the system is that the application has a feature, referred to herein as a constructor engine, whereby the displayed product can be customized on the application. Once customized, the customized article can be retrieved from storage or assembled and delivered to the customer. Various additional features are afforded by the system.

The flow diagram includes the following steps:

At step 102 a MAC address of an NFC tag is associated with an SKU in a database, the SKU describing an article collocated with the NFC tag.

At step 104 a GUI is provided on a computing device, the computing device being in communication with the database. At step 106 a representation of the article collocated with the NFC tag is displayed on the GUI when the computing device communicates with the NFC tag.

At step 108 a set of alternative components is provided on the GUI (e.g., in menus), where the alternative components can be selected to substitute existing components of the article displayed on the GUI.

At step 110 a selected alternative component, of the set of alternative components, is displayed in place of a selected existing component of the existing components of the article.

In some embodiments, the alternative components of the set of alternative components are compiled from other SKUs in the database.

In some embodiments, the alternative components of the set of alternative components have dimensions (e.g., of size and shape) that are similar to the existing components, having a predefined threshold by which the dimensions are allowed to differ from corresponding dimensions of the existing components.

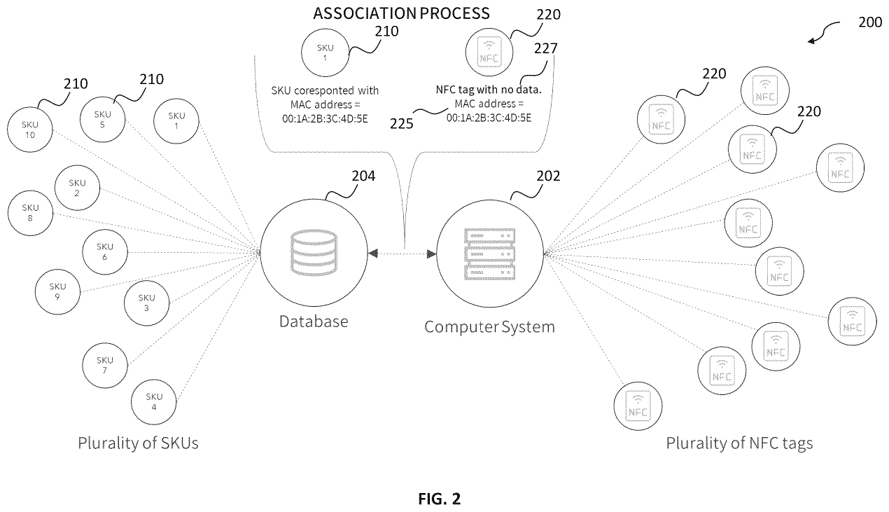

The process is now described in further detail. FIG. 2 illustrates a diagrammatic representation of an example system according to the present invention.

FIG. 2 illustrates a system 200 including a computer system 202 having a database 204 including a plurality of SKUs 210 a plurality of NFC tags 220 that are each collocated with a respective article 10 and configured to be associated with a corresponding SKU by associating a MAC address 225 of one NFC tag with a corresponding SKU in the database, wherein the data fields 227 of the NFC tags are empty.

### Properties of the NFC Tag

RFID or NFC generic tag. Each tag has a unique MAC address. The tag also has information fields. The information fields are left empty and it is the MAC address that is loaded into the system database and the information regarding the article that the tag is attached to, or collocated with, is loaded into the database record fields. The tags can be the cheapest tags on the market, with minimal storage, as no storage is needed.

As such, no information is loaded onto the tag. All the information is stored in the database. When the tag is scanned by the user, there is no information on the tag, but if the scanning device is connected to, or in communication with, the store's computer system, and more specifically the tag information database stored on the computer system, then the scanning device will be able to provide the relevant information to the user of the scanning device.

### Tag Setup.

Specifically, an example embodiment of the method includes employing an administrative scanning device—i.e., a scanning device in communication with the company computer system, where the scanning device has read and write permissions on the system database. The tag is scanned to read the tag's MAC address. This MAC address is then associated with an existing Stock Keeping Unit (SKU), for example, in the computer database.

An SKU is used by retailers to identify and track its inventory, or stock. A SKU is a unique code consisting of letters and numbers that identify characteristics about each product, such as manufacturer, brand, style, color, and size.

### User Experience

A customer or potential consumer is able to participate and enjoy the user experience with the help of an NFC or RFID enabled mobile device with a user interface. Many smartphones are equipped with NFC capabilities (i.e., have an NFC antenna installed with the necessary hardware and/or firmware in the phone). According to one example embodiment, the system includes a downloadable application that the customer can install on their smartphone (or tablet, etc.) which then employs the NFC capabilities to scan the tag.

Alternatively, the store may provide a smart device (smartphone, tablet, or dedicated machine) with these capabilities.

Generally speaking, the NFC tag is charged or powered by the electromagnetic field of the smartphone (or other device) as the device is brought into proximity with the tag. The power is sufficient for the tag to communicate the MAC address of the tag to the NFC enabled device. The system application installed on the smart device communicates with the store's computer database to access the SKU associated with the tag, and hence the article/commodity with which the tag is collocated and logically associated.

### QR Code Embodiment

In some embodiments, instead of providing an NFC tag, the article can be associated with a unique QR code. Once scanned, a web page corresponding to the article for sale pops up on the smartphone. However, this embodiment necessitates the existence or creation of a dedicated webpage for each article.

By contrast, the GUI of the NFC embodiment may be dynamic in that the interactive Constructor Page (which displays the article and facilitates customization thereof) of the app (or website) imports, according to some embodiments, the components of the SKU associated with the NFC tag and assembles the 3D model (or even the 2D image) from the components detailed in the various description fields of the SKU. According to other embodiments, the interactive constructor page (of the app or system website) imports one or more images (e.g., photographs of the article on display) of the article or even a composite model of the article, as above.

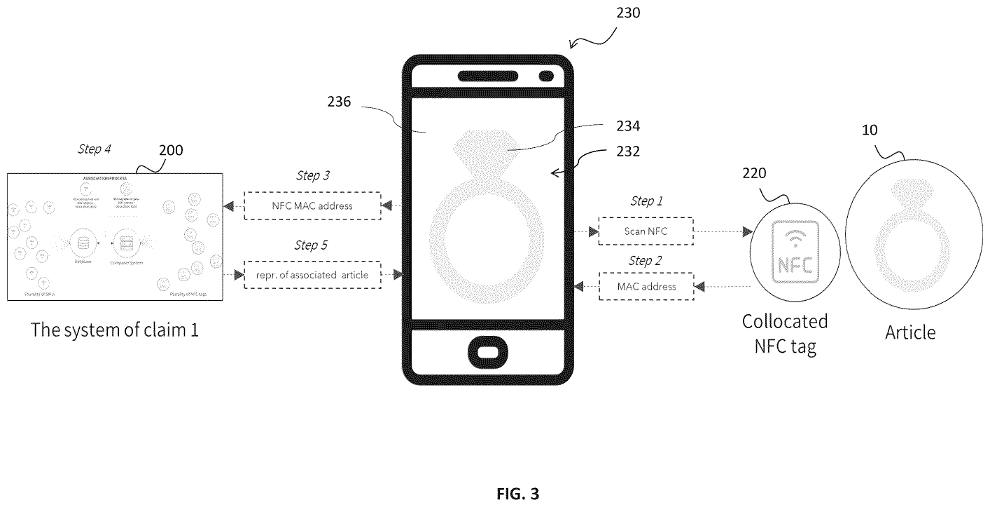

FIG. 3 illustrates an example embodiment implementing the system and process. FIG. 3 depicts system 200, further including a software application installable on a mobile device 230 (the reference number referring to the app and/or device with the app installed thereon), the software application being associated with, and in communication with, the computer system 202, wherein scanning an NFC tag 220 with the mobile device having the software application installed thereon 230 results in a GUI 232 of the software application displaying a representation 234 of the article 10 collocated with the NFC tag 220 in a display 236 of the mobile device 230.

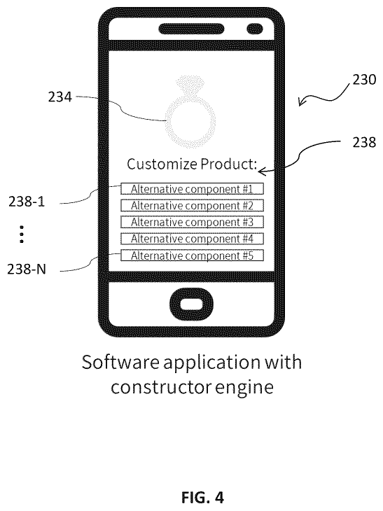

FIG. 4 illustrates an example embodiment of the GUI. FIG. 4 depicts the software application 230 includes a constructor engine 238 adapted for customizing a product by digitally substituting one or more existing components of the article with one or more corresponding alternative components selected from a set of alternative components 238-1 . . . N displayed on the GUI 232.

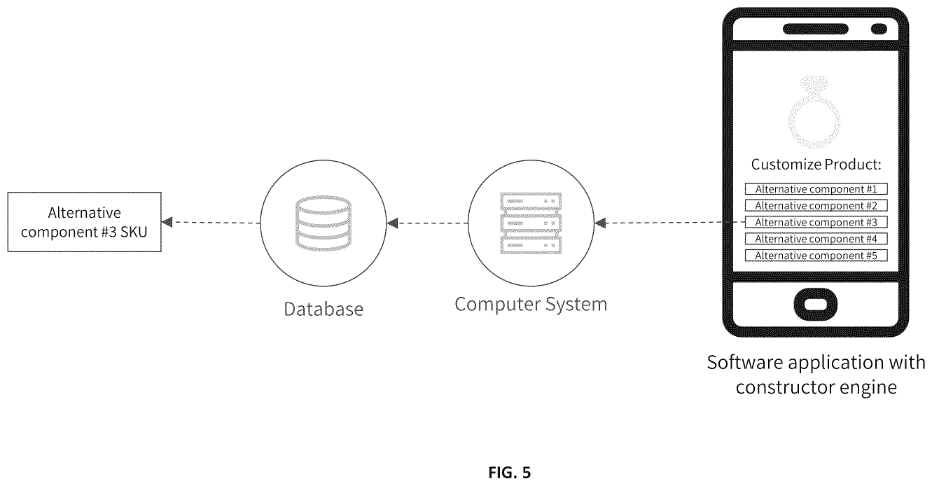

FIG. 5 depicts an optional embodiment of the invention. In some embodiments, the alternative components of the set of alternative components are compiled from other SKUs in the database. This option is depicted in FIG. 5.

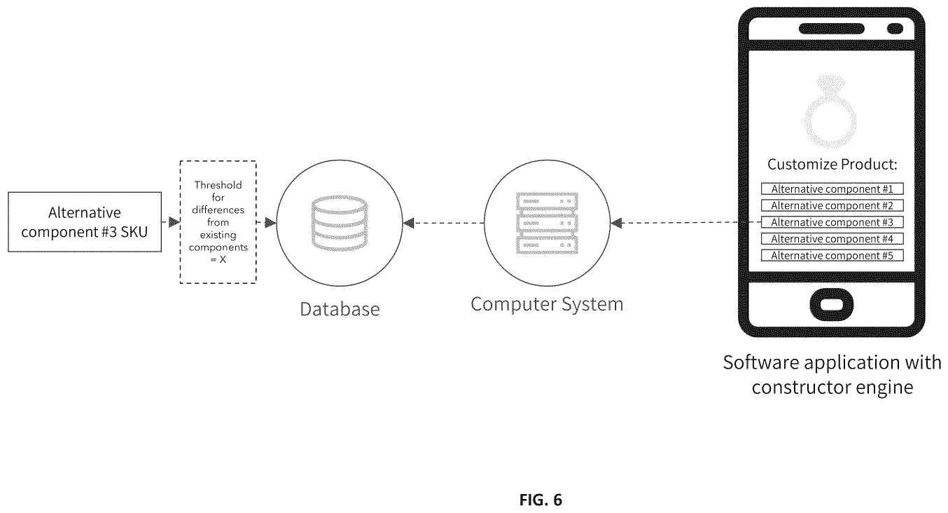

FIG. 6 depicts an optional embodiment of the invention. In some embodiments, the alternative components of the set of alternative components have dimensions of size and shape that are similar to the existing components, having a predefined threshold by which the dimensions are allowed to differ from corresponding dimensions of the existing components. This option is depicted in FIG. 6.

### Jewelry Example

According to a specific embodiment of the instant invention, the application software includes a graphic user interface (GUI) that is configured to display a representation of the article associated with the SKU/scanned tag. Preferably, the representation is an image or set of images or 3D model created from multiple images of the article, taken from different angles (perspectives, vantage points, directions, etc.).

The customer can now make changes to the product using the interface which comes preloaded with alternative features, for example, listed in various menus.

The menu of listings/alternatives, may, in some embodiments, further include a price in the menu. Accordingly, a customer can personalize a product, e.g., a piece of jewelry, such as a ring (or necklace or earrings, etc.) based on a budget. If the price for the existing article is too expensive, the customer can customize the ring with a cheaper diamond, and/or by removing side stones, and/or by changing the material of the band, etc.

In one non-limiting example that is used merely to convey the operation concept, the user scans a tag collocated with a ring. The ring is designed with a diamond fitted into a setting. Once scanned, the GUI on the smartphone/tablet shows a picture of the ring rendered into a 3D model that can be rotated and viewed from all directions. The user can select any component of the ring, in order to customize that component.

To enable this feature, the computer-rendered 3D model (or 2D images, in some cases) of the product has been further processed to tag each component separately. For example, the band of the ring is tagged as a band. The setting is tagged. The diamond is tagged. Side stones or smaller stones arranged along the band can also be tagged separately. Here, tagging means that the specific structure/component is identified individually and associated with a list or menu of alternative designs or articles for the same component.

The user can select the band (e.g., using a touchscreen interface or a pointing device such as a mouse or stylus) and then a menu of alternative types of bands are presented, for example, in the form of a menu. The user is able to select any option from the menu. When the alternative band is selected, the system substitutes the existing band with the alternative option. A hypothetical ring is now displayed. This process can now be repeated using different alternatives and/or selecting other components for modification/substitution with alternates. At the end of the process, the customer has created a composite of the desired ring. This composite may match an existing ring (e.g., one that is not displayed or is currently displayed in a different store of the same chain), or may need to be made-to-order by the company.

The menu listings/alternatives, may, in some embodiments, further include a price in the menu. Accordingly, a customer can personalize a product, e.g., a piece of jewelry, such as a ring (or necklace or earrings, etc.) based on a budget. If the price for the existing article is too expensive, the customer can customize the ring with a cheaper diamond, and/or by removing side stones, and/or by changing the material of the band, etc.

In some embodiments, the menu will only include alternatives that are held by the store (or chain, even if not held locally, but rather in a different store) or available to the store for assembly, e.g., by a skilled artisan. For example, the SKUs may detail each component of an article of jewelry (e.g., for each ring, the SKU will detail, in individual fields, the diamond type, band type, side stones, setting, etc.). The menu/list of alternatives, according to these embodiments, will be compiled by the system by drawing on all the available types of the given component from all the SKUs in the system. Therefore, a type of band, for example, that is not found in any SKU of the system, will not appear in the menu of alternative bands. According to another optional feature, components that are not in stock can be filtered out of the menus as well. This may be a default setting or an optional filter setting. In some cases, “easy” substitutes, such as color/metal type (yellow gold, white gold, platinum etc.) may always be available.

In other embodiments, the menus may be populated with all the known alternatives, e.g., drawn from an existing list or database of known types of components.

In some embodiments, only parts of the article can be customized, while others cannot be customized. For example, for a given ring, there may be a limited set of alternative diamonds that can be substituted for the existing diamond, without changing the overall design and “look” of the product. Sometimes, especially with diamonds, a similarly sized diamond may be cheaper or more expensive based on the facets, flaws, color, etc. As such, substituting the existing diamond would not change the arrangement of the rings, but would change the price of the ring.

In fact, one of the best advantages of the instant system is that the customer is able to go into a brick-and-mortar store, browse numerous products. Select one to examine more closely. In some cases, even try on the article (e.g., of jewelry) to see how it looks (on the finger, in the ear, around the neck, on the wrist, etc.). Seeing as the general appearance is not significantly, or even visually changed at all, according to some of the embodiments described above, the user gets the full impact of the article, even though the final product will be something else (e.g., assembled with a cheaper stone, and the like).

### Apparel Example

The same system can be used, mutatis mutandis, for other articles of purchase, not only jewelry. For example, a clothing shop can display various shirt styles and sizes for the customer to peruse in the store. The customer selects a short-sleeved button-down shirt according to his or her size and brings the smartphone into proximity with the associated NFC tag. The app or website loads on the mobile device and the user is able to interact with the interface to customize or select a specific shirt. For example, the user can select the color and/or print of the shirt, the type of collar, with or without a pocket etc. The user can try on the shirt for fit and comfort, but order, or select (see below) the specific or customized version.

The instant system may reduce the necessary store size, as the majority of the inventory can be shelved in the storage area of the store, and only the representative or basic articles are put out on display. Once the user has selected the exact version of the article, a store employee can be dispatched to retrieve the exact article from the storage area. If the customized article is not available in the store, it may be sent to the user, e.g., in a package via messenger. In fact, in some cases, the shops may store all of their inventory off-site, and only provide the option of ordering the desired article which will then be messengered to the customer's home.

### In-Store Product Placement

In-store product placement is the art of determining where your products appear within a retailer through planning, negotiation, and design. The present system also creates a statistical map of preferred products. Over time, a statistical database grows, for example, with the number of times each article is selected for review by customers (i.e., the number of distinct instances that an NFC tag is scanned), the types of changes that are routinely made using the constructor engine, a map of which tags are scanned by an individual customer, in what order, and the like. It may become apparent, for example, that one display case or display area gets more “traffic”, regardless of which specific articles in that display case or area are selected. In fact, having many different articles scanned in the same area may actually be an indication that the location and/or arrangement of the articles is the cause of the traffic, more so than the article itself that is placed there. Store owners can utilize statistical data to position the articles in the preferred space. The statistical data can also include, for example, which articles are most commonly purchased (to have that article well stocked), which modifications are commonly made (to keep the popular modified articles in stock), and, on the flip side, which articles are not being bought or even shown interest in.

The statistical information can also be used for remarketing purposes. The system is aware of articles that were scanned, even though in the end they were not purchased. This information can now be used for target marketing purposes. Once the user leaves the store, he or she can be sent targeted ads for the same or similar products to the product that was not purchased. The system knows that the user has shown interest but did not follow through with the purchase. This is an indication that the customer may be open to purchasing this article or a similar article in different circumstances. The user may then be targeted with discount offers for that article, e.g., via push notification adverts, or notified when that article goes on sale.

In preferred embodiments, the brick-and-mortar establishment is semi-automated or even fully automated. To that end, the computerized system includes automation modules receiving information from data sources, indicating a certain trigger (nexus between physical item and consumer, where the trigger is facilitated by technological means), wherein the trigger is associated with a certain consumer behavior and certain applicable actions, allowing the automation module or modules to guide autonomous decision-making and automated actions that align with observed consumer behavior. In embodiments, the automation module may include trained machine learning models and/or artificial intelligence (AI) software and/or circuitry to guide and assist in decision-making.

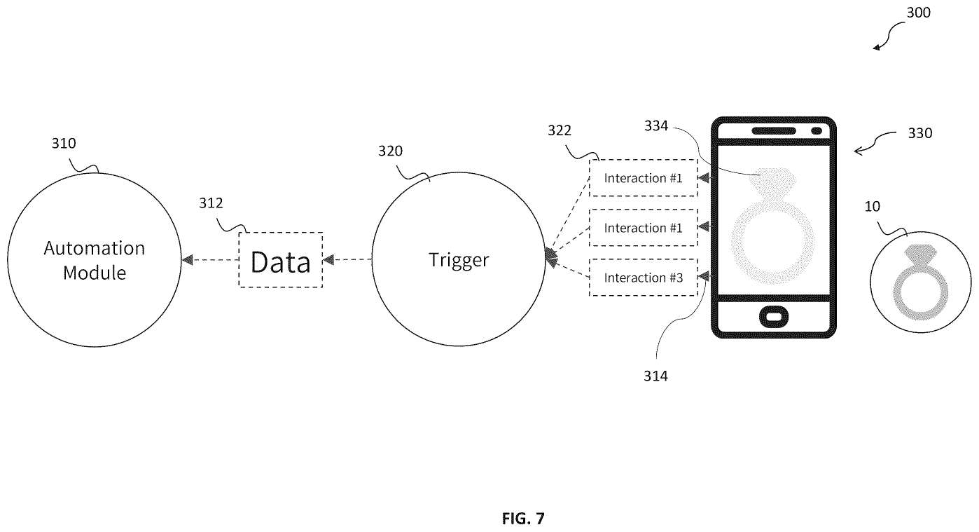

FIG. 7 illustrates a diagrammatic representation of an example embodiment of the invention. FIG. 7 depicts a system 300 including an automation module 310 configured to receive data 312 in response to a trigger 320. The trigger 320 is indicative of an interaction 322 between a physical item 10 and a consumer (not shown). The data including information related to the consumer. A user interface 330 configured to facilitate interactions between the consumer 20 and a digital representation of the physical item 334. The automation module 310 is configured to collect interaction data 314 from the interactions between consumer and the digital representation 334.

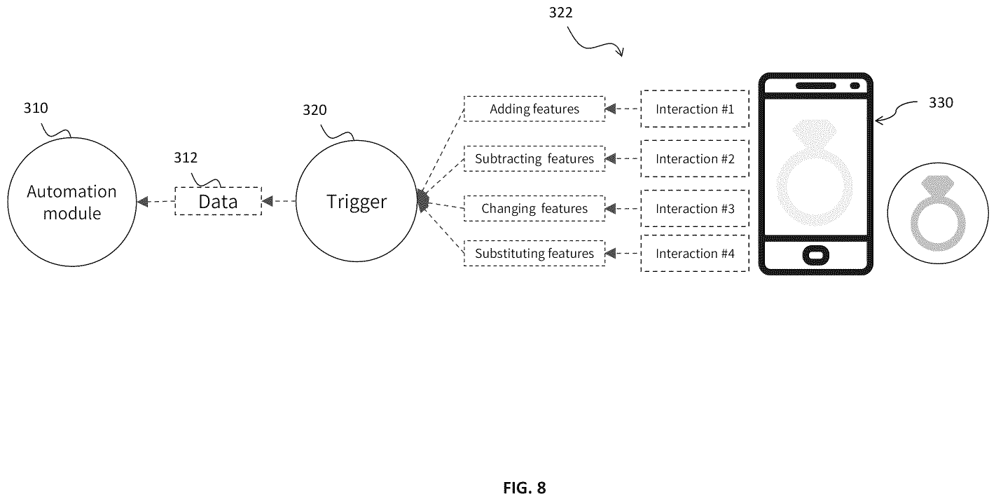

FIG. 8 illustrates an example embodiment according to FIG. 7. In an example embodiment, the interactions 322 include adding, subtracting, changing, and/or substituting features of the digital representation.

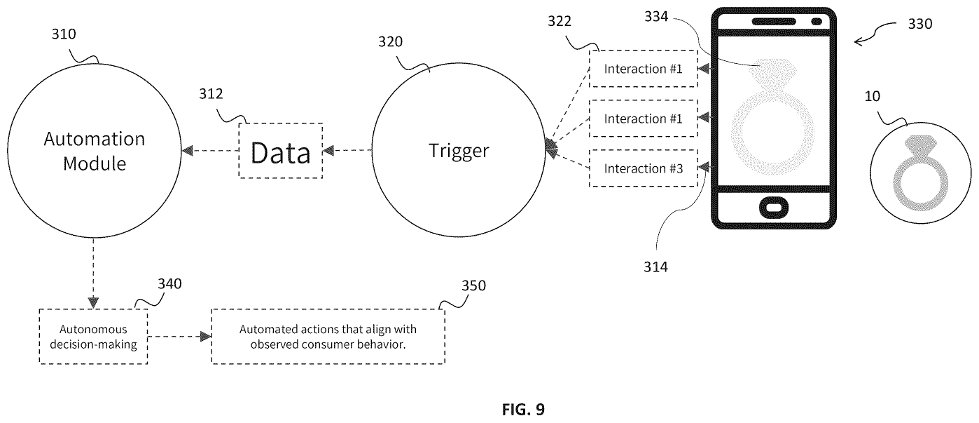

FIG. 9 illustrates a diagrammatic representation of an example embodiment including autonomous decision-making and/or automated actions. In embodiments, the automation module 310 facilitates autonomous decision-making 340 and/or automated actions 350 that align with observed consumer behavior.

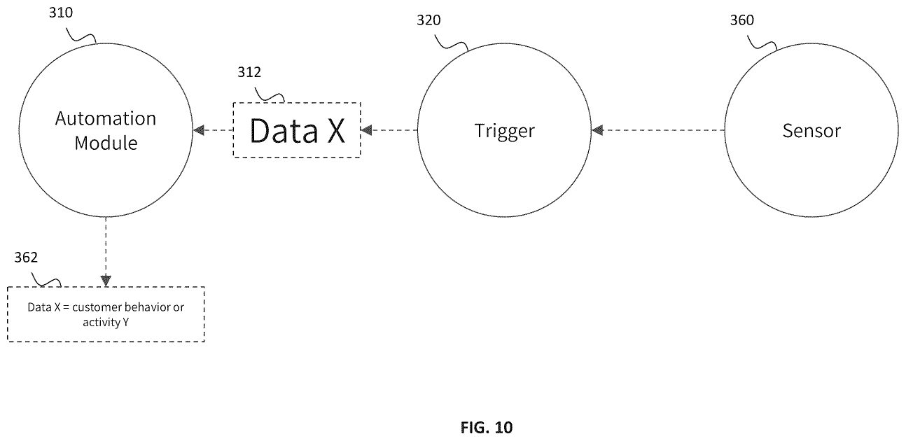

FIG. 10 illustrates an example embodiment whereby data is received from a data source 360, such as a sensor. In embodiments of the system the data is received from a data source 360, the data being indicative of a customer behavior or activity 362. In example embodiments, the data source is a sensor 360.

In more detail, the data sources may be any source of data, such as, for example, data from one or more sensors. Sensors include, but are not limited to: proximity sensors, motion sensors, imaging sensors (video, stills), sensors for reading biometric data, sensors for reading, sending, and/or receiving contact or contactless signals and the like. Biometric data sensors may include: finger- and palm-print sensors, imaging sensors with image processing software, e.g., for facial recognition, audio sensors, retinal sensors, and the like. Contactless or wireless signal sensors include, but a definitely not limited to: communications technologies (transmitters, receivers, and/or processors) such as NFC, Bluetooth, BLE (Bluetooth low energy), WiFi, cellular, RFID, barcode and QR code generators and readers, and the like. Contact based signals may include pin codes entered via a keypad, card readers that read the magnetic stripe of a card such as a credit card or membership card and the like.

According to embodiments, the present invention employs the collaboration of a trigger (e.g., from a sensor and/or other data/signal source) that is associated with a physical commodity (or representation thereof) in a physical (as opposed to virtual) environment, such as a brick-and-mortar establishment, where the trigger indicates that a consumer has shown interest in the physical commodity.

Once there is a trigger, the automation modules, that receive the information from data sources (e.g., sensors, etc.), process the customer behavior that activated the trigger and, where deemed applicable, enable a process to autonomous decision-making and automated actions that align with observed consumer behavior. Some examples have been provided above with regards to jewelry and apparel. These processes may be semi-automated or even fully automated, as mentioned above.

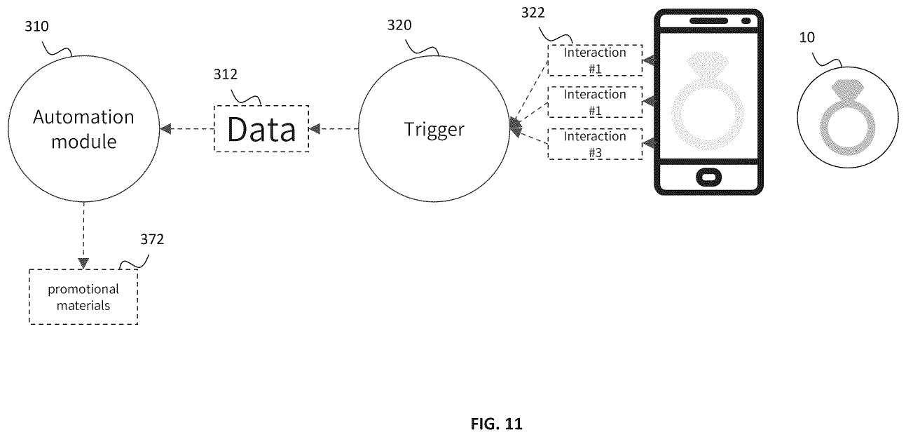

FIG. 11 illustrates an example embodiment of the system wherein the interaction data 314 is used to produce promotional materials 372.

In some embodiments, the automation module automatically updates marketing campaigns based on the designs of the most viewed products in each store branch. These updates may even include changes to the featured product designs in digital advertisements (also referred to herein as promotional materials and ads) and updates to the suggested products in email marketing communications.

In some embodiments, an automation module creates promotions for products that are infrequently viewed in each store branch. These promotions may include discounts on the infrequently viewed products, special offers that combine infrequently viewed products with popular products, and targeted advertising campaigns that highlight the unique features of infrequently viewed products and the like.

In embodiments, the automation module adjusts the promotions in advertising to the most common customer budget ranges in each store branch. These adjustments may include the automatic selection of products to feature in advertisements based on the average customer budget at each branch and the customization of advertising content to highlight products within the average budget range.

In embodiments, the automation module uses the data to segment the customer audience based on their preferences and behaviors for targeted advertising campaigns. In embodiments, the automation module adjusts the creative elements of advertisements dynamically based on the data about each audience segment's preferences and behaviors. In embodiments, the automation module informs a bidding strategy on programmatic ad (advertising) platforms using the data, including adjusting bids for ads featuring popular products in specific geographic areas.

In some embodiments, the automation module creates lookalike audiences on ad platforms based on the data about current customers' interactions with the NFC tags/app or other sensors. In embodiments, the automation module creates retargeting campaigns that aim to re-engage customers who have interacted with the NFC tags/app or other sensors but have not made a purchase.

In embodiments, the automation module adjusts the geo-targeting settings on programmatic ad platforms based on the data about customer interactions at each store location. In embodiments, the automation module adjusts ad scheduling on programmatic ad platforms based on the data about when customers are most likely to interact with the NFC tags/app or other sensors. In embodiments, the automation module informs a strategy for launching new products on programmatic ad platforms based on the data about customer interactions with the NFC tags/app or other sensors.

In embodiments, the automation module uses the data to inform a content marketing strategy, including creating and promoting content based on customer preferences and behaviors.

In embodiments, the automation module uses the data to conduct market research, identifying trends in customer preferences and behaviors that inform future product development and marketing strategies. In embodiments, the automation module uses the data to map the customer journey, identifying opportunities to optimize that journey and increase conversions. In embodiments, the automation module personalizes advertisements shown to customers based on their preferences and past interactions as indicated by the data. In embodiments, the automation module uses the data to understand which advertisements are most effective in driving customer engagement and purchases and adjusts the advertising strategy accordingly.

In embodiments, the automation module uses the data to manage inventory across different store locations based on customer interest and engagement with different products.

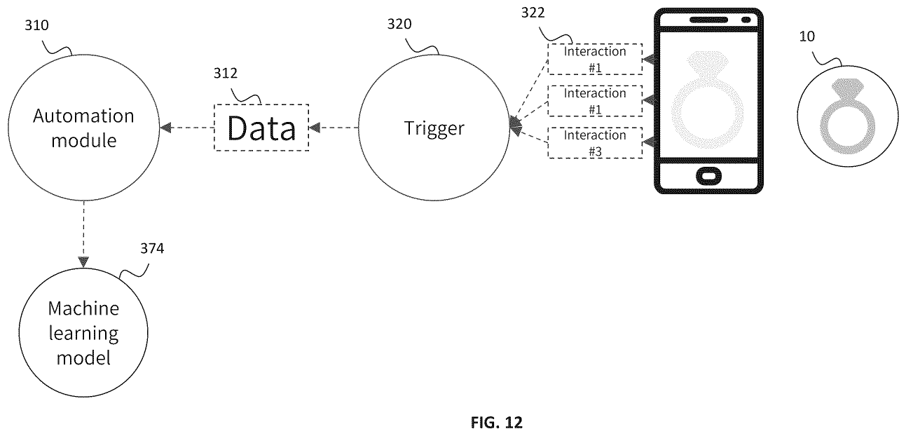

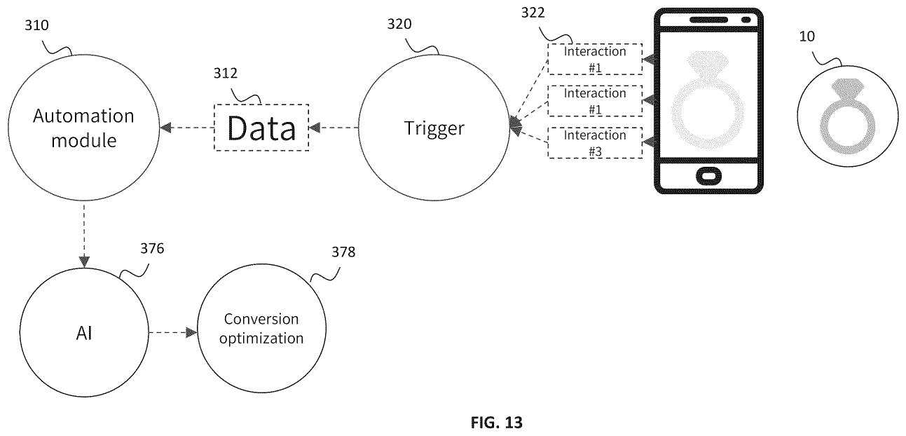

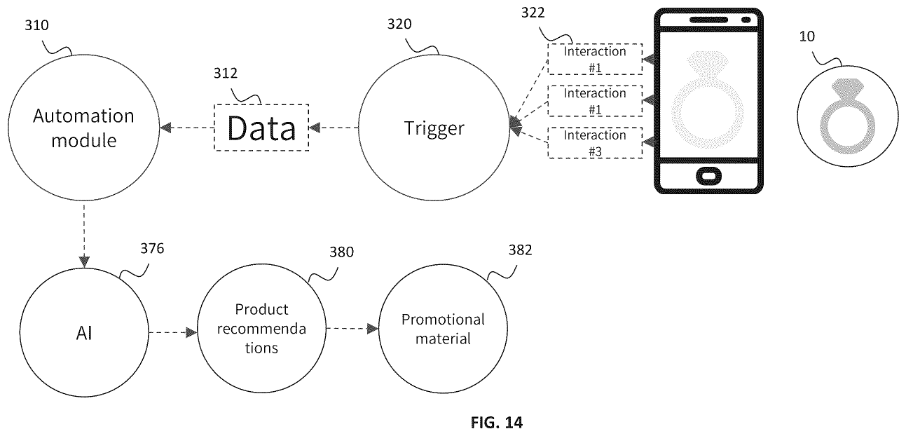

FIG. 12 illustrates an example embodiment of the system where the interaction data 314 is used to train machine learning models 374. FIG. 13 illustrates an example embodiment of the system where the interaction data 314 is used by artificial intelligence software 376 to improve conversions 378. FIG. 14 illustrates an example embodiment of the system where the automation module uses artificial intelligence (AI) 376 to analyze the interaction data 314 to predict which products 380 the customer is likely to be interested in and target promotional material 382 accordingly.

In embodiments, the automation module uses AI to generate ad designs based on the data about customer preferences and behaviors. In embodiments, the automation module informs AI-powered chatbots that provide personalized product recommendations to customers based on the data about their past interactions and preferences. In embodiments, the automation module uses AI to analyze the data and predict which products a customer is likely to be interested in, and targets ads accordingly.

In embodiments, the automation module uses AI to analyze the data and determine the optimal placement for ads on different platforms to maximize engagement and conversions. In embodiments, the automation module uses AI to analyze customer feedback and reviews to inform ad targeting and creative. In embodiments, the automation module uses AI to generate ad copy based on the data about customer preferences and behaviors.

In embodiments, the automation module uses AI to analyze the data and identify patterns in customer behavior that can inform the ad targeting strategy. In embodiments, the automation module uses AI to automatically run A/B tests of different ads and targeting strategies and optimizes based on the results. In embodiments, the automation module uses AI to analyze the data and implement dynamic pricing in ads, offering personalized prices based on factors like demand and customer behavior.

In embodiments, the automation module uses AI to create personalized video ads based on the data about customer preferences and behaviors. In embodiments, the automation module uses AI to optimize ads for voice search, based on the data about how customers describe and search for products. In embodiments, the automation module uses AI to analyze the data and identify the contexts in which customers are most likely to be interested in the products, and targets ads accordingly. In embodiments, the automation module uses AI to analyze the data and determine the optimal timing and content for retargeting ads to customers who have interacted with the NFC tags and app but haven't made a purchase.

In embodiments, the automation module uses AI to analyze the data and optimize ads and website for conversions, based on factors like customer behavior and preferences. In embodiments, the automation module uses AI to analyze the data and coordinate advertising campaigns across multiple channels for maximum impact.

In embodiments, the automation module creates a sequence of ads that aligns with the customer's journey, such as an initial ad featuring a ring design, a subsequent ad highlighting the benefits of the customer's preferred diamond type, and a final ad offering a discount if they make a purchase within a certain timeframe.

In embodiments, the automation module uses AI to analyze the data and identify the contexts in which customers are most likely to be interested in your products, and targets ads accordingly, such as targeting a customer who often designs rings while browsing fashion-related content with ads on fashion websites.

In embodiments, the automation module uses the demographic data to create ads tailored to specific demographics, such as creating ads that feature a popular ring design in a specific area of residence. In embodiments, the automation module uses the budget preference data to create ads that feature rings within a certain budget range, with different ad sets for low, medium, and high budget preferences.

In embodiments, the automation module uses the data on ring design preferences to dynamically adjust the creative elements of ads, such as showing a customer, who prefers a certain diamond shape, ads that include diamonds of that preferred shape.

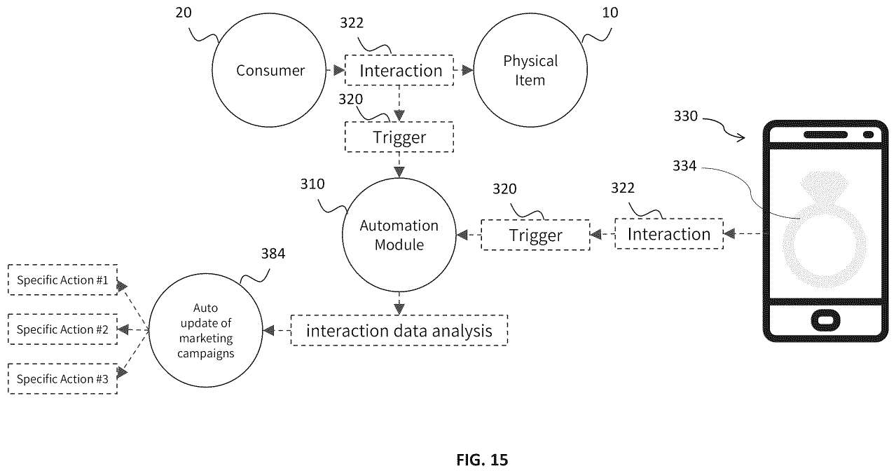

FIG. 15 depicts an example embodiment of the invention. FIG. 15 illustrates a system including an automation module 310 configured to receive data in response to a trigger 320, wherein the trigger is indicative of an interaction 322 between a physical item 10 and a consumer 20, the data including information related to the consumer. The system includes a user interface 330 configured to facilitate interactions between the consumer and a digital representation 334 of the physical item 10. The automation module 310 is configured to collect interaction data from the interactions 322 between consumer 20 and the digital representation 334.

The automation module automatically updates marketing campaigns 384 based on designs of most viewed products in each store branch based on the interaction data. The automation module adjusts promotions 382 in advertising to most common customer budget ranges in each store branch. The adjustments including automatic selection of products to feature in advertisements based on the average customer budget at each branch and the customization of advertising content to highlight products within the average budget range.

### Machine Learning

The application, in some embodiments, employs machine learning algorithms. One learned behavior may be a suggestion feature whereby the app or website tracks which articles are scanned and then make a suggestion along the lines of: “people who viewed these products also viewed the following products”, with directions, for example, indicating where to find the product.

Machine Learning can be employed in other ways. One non-limiting example is a machine learning engine that can provide guidance after being trained on a large enough data set. Many questions are frequently repeated, and the AI or machine learning model can be trained on these questions and the accompanying answers. The app or system can then provide guidance in place of a human employee. Any question a customer has can be asked to the system and AI/ML logic will be able to provide the necessary answers, and possibly even the most effective answers, that would be given by the most experienced people in the business.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. A non-transitory computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable non-transitory storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes and is not intended to limit any of such computer-implemented methods disclosed herein.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A system comprising:
a computer system having a database including a plurality of SKUs;
a plurality of NFC tags that are each collocated with a respective article and configured to be associated with a corresponding SKU by associating a MAC address of one NFC tag with a corresponding SKU in the database, wherein the data fields of the NFC tags are empty.

2. The system of claim 1, further comprising:
a software application installable on a mobile device, the software application being associated with and in communication with the computer system, wherein scanning an NFC tag with the mobile device having the software application installed thereon results in a GUI of the software application displaying a representation of the article collocated with the NFC tag in a display of the mobile device.

3. The system of claim 2, wherein the software application includes a constructor engine adapted for customizing a product by digitally substituting one or more existing components of the article with one or more corresponding alternative components selected from a set of alternative components displayed on the GUI.

4. The system of claim 3, wherein the alternative components of the set of alternative components are compiled from other SKUs in the database.

5. The system of claim 3, wherein the alternative components of the set of alternative components have dimensions of size and shape that are similar to the existing components, having a predefined threshold by which the dimensions are allowed to differ from corresponding dimensions of the existing components.

6. A system comprising:
an automation module configured to receive data in response to a trigger, wherein the trigger is indicative of an interaction between a physical item and a consumer, the data including information related to the consumer;
a user interface configured to facilitate interactions between the consumer and a digital representation of the physical item;
wherein the automation module is configured to collect interaction data from the interactions between consumer and the digital representation.

7. The system of claim 6, wherein the automation module facilitates autonomous decision-making, automated actions that align with observed consumer behavior, or both.

8. The system of claim 6, wherein the data is received from a data source, the data being indicative of a customer behavior or activity.

9. The system of claim 6, wherein the data source is a sensor.

10. The system of claim 6, wherein the interactions include adding, subtracting, changing, and substituting features of the digital representation.

11. The system of claim 6, wherein the interaction data is used to produce promotional materials.

12. The system of claim 6, wherein the interaction data is used to train machine learning models.

13. The system of claim 6, wherein the interaction data is used by artificial intelligence software to improve conversions.

14. The system of claim 6, wherein the automation module uses artificial intelligence (AI) to analyze the interaction data to predict which products the customer is likely to be interested in and target promotional material accordingly.

15. A system comprising:
an automation module configured to receive data in response to a trigger, wherein the trigger is indicative of an interaction between a physical item and a consumer, the data including information related to the consumer;
a user interface configured to facilitate interactions between the consumer and a digital representation of the physical item;
wherein the automation module is configured to collect interaction data from the interactions between consumer and the digital representation;
wherein the automation module automatically updates marketing campaigns based on designs of most viewed products in each store branch based on the interaction data; and
wherein the automation module adjusts promotions in advertising to most common customer budget ranges in each store branch, the adjustments including automatic selection of products to feature in advertisements based on the average customer budget at each branch and the customization of advertising content to highlight products within the average budget range.
